(19) United States
(12) Patent Application Publication
(10) Pub. No.: US 2024/0020086 A1
(43) Pub. Date: Jan. 18, 2024

(54) MEDIA NAVIGATION VIA WAVEFORM ANALYSIS AND MICRO-ADJUSTMENTS OF USER NAVIGATION REQUESTS

(71) Applicant: AUDACY OPERATIONS, INC., Philadelphia, PA (US)

(72) Inventors: Vitaly Shoyket, Broomfield, CO (US); Brian Scott Bosworth, Edgewater, MD (US); Jeremiah Matthew Jones, Jacksonville, FL (US); Justin Byron Filion, Washougal, WA (US); Michelle Benninghoven, Ogden, UT (US)

(73) Assignee: AUDACY OPERATIONS, INC., Philadelphia, PA (US)

(21) Appl. No.: 17/867,519

(22) Filed: Jul. 18, 2022

(51) Int. Cl. G06F 3/16; G10L 25/51

(52) U.S. Cl. CPC G06F 3/165; G10L 25/51

(57) ABSTRACT

A method of navigating a media stream includes streaming a media stream to a user device, wherein the media stream comprises a plurality of media segments, and each media segment of the plurality of media segments corresponds to a non-overlapping portion of the media stream. Additionally, the method includes receiving, from the user device, a request to navigate from a current position in the media stream to a requested position in the media stream. Further, the method includes locating a media segment of the plurality of media segments, wherein the media segment corresponds to the requested position in the media stream. Moreover, the method includes determining an optimal position within the media segment based on one or more waveform criteria. Finally, the method includes streaming the media stream to the user device from the optimal position in the media segment.

### TECHNICAL FIELD

The disclosed implementations relate generally to media navigation. In particular, the disclosed implementations relate to using waveform analysis to improve media-stream navigation by making micro-adjustments to user navigation requests.

### BACKGROUND

In navigating media (e.g., audio, video), users sometimes navigate to the middle of a loud noise or a high-pitched sound. For example, when skipping ahead through a song, a user might navigate to the middle of a cymbal crash in a classical piece, or the middle of a high-pitched harmonic tone in a guitar solo. For many users, this can be jarring. Accordingly, an improved form of media navigation is desired.

### SUMMARY

The following disclosure provides a description of methods, electronic devices, and non-transitory, computer-readable mediums for navigating media. The methods, electronic devices, and non-transitory, computer-readable mediums disclosed herein relate to micro-adjustments (e.g., plus fifty milliseconds, minus two seconds) to user navigation requests. These micro-adjustments, when made in accordance with waveform criteria, avoid unintentional navigation into—for example—especially loud sounds, high-pitched tones, or other undesired navigation points.

Some implementations provide a method for navigating a media stream. The method includes streaming a media stream to a user device, wherein the media stream includes a plurality of media segments, and each media segment of the plurality of media segments corresponds to a non-overlapping portion of the media stream. Additionally, the method includes receiving a request from the user device to navigate from a current position in the media stream to a requested position in the media stream. Further, the method includes locating a media segment of the plurality of media segments, wherein the media segment corresponds to the requested position in the media stream. Also, the method includes determining an optimal position within the media segment based on one or more waveform criteria. Finally, the method includes streaming the media stream to the user device from the optimal position in the media segment.

In some embodiments, determining the optimal position within the media segment based on the one or more waveform criteria includes determining one or more potential positions within the media segment that satisfy a primary waveform criterion of the one or more waveform criteria, and selecting the optimal position from among the one or more potential positions based on at least a secondary waveform criterion of the one or more waveform criteria. In some embodiments, the primary waveform criterion is an antecedent criterion that is satisfied by any navigation position that is temporally antecedent to the requested position in the media stream. In some embodiments, the primary waveform criterion is an amplitude criterion that is satisfied by any navigation position that has an audio waveform amplitude less than an amplitude threshold. In some embodiments, the method further includes varying the secondary waveform criterion until only one potential position of the one or more potential positions satisfies the secondary waveform criterion.

In some embodiments, each criterion of the one or more waveform criteria includes a threshold and a weight, wherein the weight is associated with an importance of the criteria. In some embodiments, determining the optimal position within the media segment based on the one or more waveform criteria includes determining one or more potential positions within the media segment that satisfy a primary waveform criterion of the one or more waveform criteria, wherein the weight of the primary waveform criterion is greater than or equal to the weight of each other criteria of the one or more waveform criteria, and selecting the optimal position from among the one or more potential positions based on at least a secondary waveform criterion of the one or more waveform criteria. In some embodiments, the method further includes varying the threshold of the secondary waveform criterion until only one potential position of the one or more potential positions satisfies the secondary waveform criterion.

In some embodiments, the one or more waveform criteria include an amplitude criterion that is satisfied by any navigation position that has an audio waveform amplitude less than an amplitude threshold. In some embodiments, the one or more waveform criteria include a frequency criterion that is satisfied by any navigation position that has an audio waveform frequency less than or equal to a frequency threshold. In some embodiments, the one or more waveform criteria include a proximity criterion that is satisfied by any navigation position that has a distance from the requested position that is less than a proximity threshold. In some embodiments, the one or more waveform criteria include an antecedent criterion that is satisfied by any navigation position that is temporally antecedent to the requested position in the media stream. In some embodiments, the one or more waveform criteria include a subsequent criterion that is satisfied by any navigation position that is temporally subsequent to the requested position in the media stream.

In some embodiments, the method further includes displaying, at the user device, an indication of the current position in the media stream and an option to navigate from the current position in the media stream to the other portion of the media stream. In some embodiments, the optimal position in the media stream is different from the requested position in the media stream. In some embodiments, the media stream includes audio media. In some embodiments, the media stream includes video media. In some embodiments, the media stream includes a live stream.

Some implementations provide an electronic device that includes one or more processors and memory storing one or more programs. The one or more programs include instructions, which, when executed by the one or more processors, cause the electronic device to perform the method of any of the aforesaid embodiments. Other implementations provide a non-transitory, computer-readable medium that stores one or more programs. The one or more programs include instructions, which, when executed by one or more processors of an electronic device, cause the electronic device to perform the method of any of the aforesaid embodiments.

### BRIEF DESCRIPTION

The implementations disclosed herein are illustrated by way of example, and not by way of limitation, in the figures of the accompanying drawings. Like reference numerals refer to corresponding parts throughout the drawings.

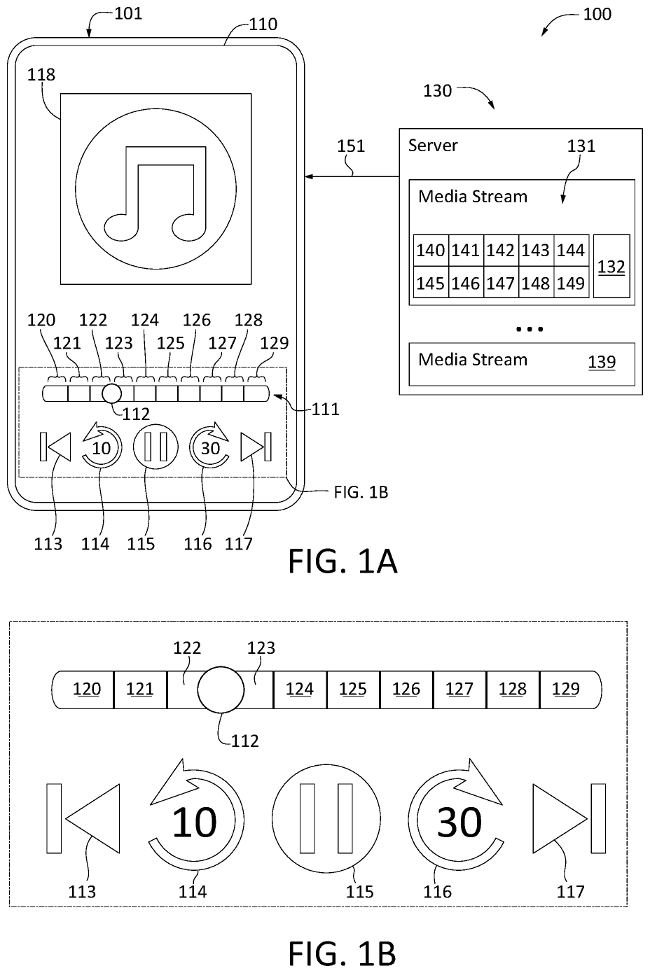

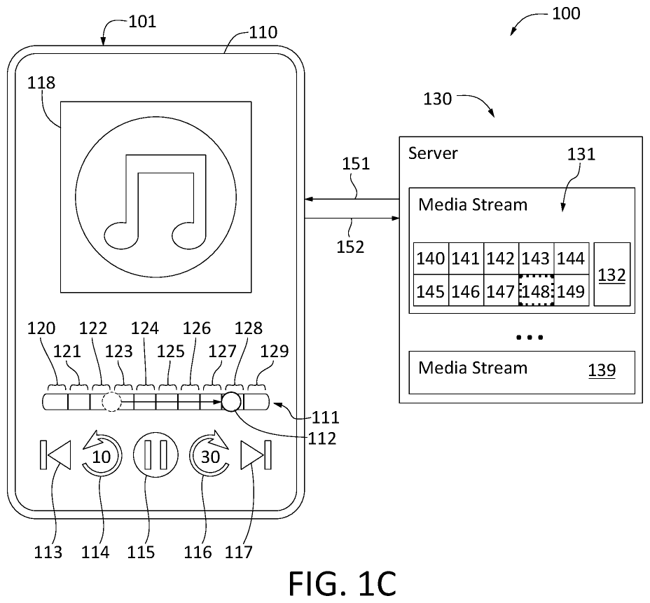

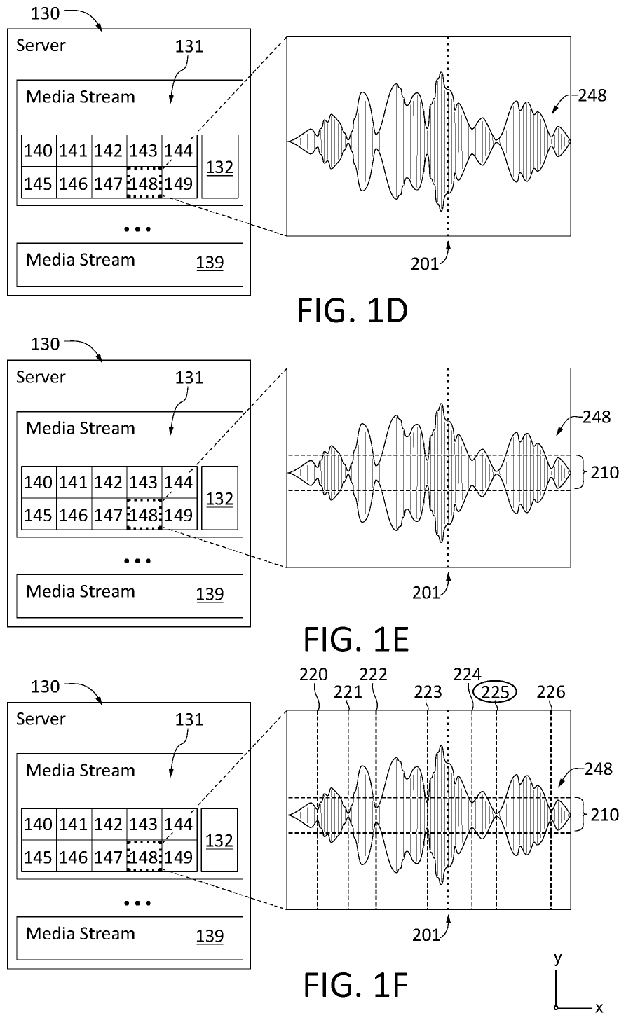

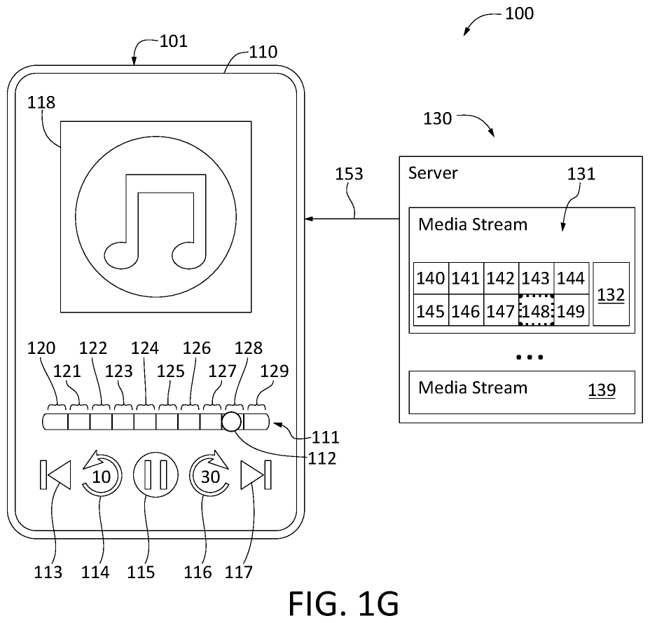

FIGS. 1A-1G illustrate a system for navigating media according to waveform criteria.

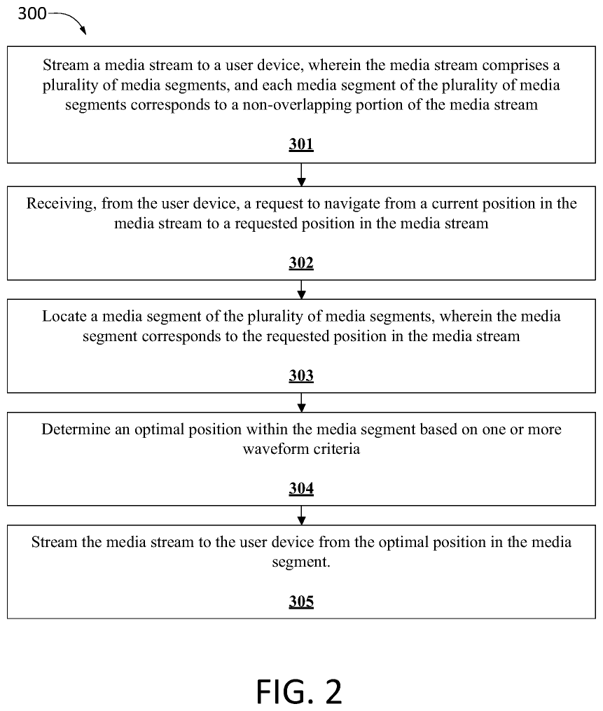

FIG. 2 illustrates a method for navigating media according to waveform criteria, in accordance with some implementations.

### DETAILED DESCRIPTION

FIGS. 1A-1G illustrate a system 100 for implementing one or more embodiments of the inventions described herein. In some embodiments, the system 100 may include a user device 101 and a server 130.

The system 100 may include one or more computers having one or more processors and memory (e.g., one or more non-volatile storage devices) to stream live and time-shifted audio content to a client device according to at least one embodiment of the present invention. Memory, or a computer-readable storage medium of memory, may store programs, modules and data structures, or subsets thereof, for a processor to control and run the various systems and methods disclosed herein. The system 100 may include a non-transitory computer readable storage medium having stored thereon computer-executable instructions that, when executed by a processor, perform one or more of the methods disclosed herein.

In the discussion that follows, a client device (e.g., user device 101) that includes a processor, a display (e.g., user interface 110) and an audio output device is described. It should be understood, however, that the client device optionally includes one or more other physical user-interface devices, such as a physical keyboard, a touch-sensitive display, a mouse, a joystick, a microphone, and a remote control.

Server 130 is referenced in the below description. It will be understood that a server may refer to a computing device that provides data to other computing devices including, but not limited to, other servers and client computing devices. The server 130 may transmit the data over a local area network (LAN) or a wide area network (WAN) or over the internet, as well as among other data transmission mediums. The server 130 may provide different services described herein and include software capable of providing those services. The server 130 may also host software suitable for video/radio broadcasting and streaming media streams. The term “streaming” is consistently used as well; it will be understood that streaming can refer to either the steady, continuous flow of data transmission or reception over a computer network. The terms “stream” and “transmit” may be used interchangeably throughout the specification.

Turning now to FIG. 1A, there is illustrated an example user interface 110 of the user device 101 that is receiving media from the server 130, in accordance with some implementations. As illustrated, the user device 101 (e.g., a computer, a tablet, a smartphone, a smartwatch) may display the user interface 110. The user interface 110 may include a graphic 118 (e.g., album art, a music video) in embodiments where the user device is streaming or playing media that includes audio (e.g., a song, a podcast). Alternatively, the user interface 110 can include a video player 118 in embodiments where the user device is streaming or playing media that includes video (e.g., a music video, a television show, a slideshow).

The user interface 110 can also include a scrubber bar 111 and a cursor 112. The cursor 112 may travel (e.g., from left to right) along the length of the scrubber bar 111 as media is streamed or played. For example, when the device begins streaming or playing media (i.e., from the beginning of said media), the cursor 112 is located at the leftmost portion of the scrubber bar 111. As another example, when the user device 101 finishes streaming or playing the media (e.g., when it reaches the end of the media), the cursor 112 is at the rightmost portion of the scrubber bar 111. Accordingly, the scrubber bar 111 and the cursor 112 together indicate how much of the media has already streamed or played, and how much of the media remains to be streamed or played. For example, in FIG. 1A, the scrubber bar 111 and the cursor 112 suggest the user is nearing the midway point of the media because the cursor 112 is nearing the middle of the scrubber bar 111.

The scrubber bar 111 may allow the user to navigate the media. For example, as discussed in more detail below, the user can select (e.g., tap, click, press) the cursor 112 and drag the cursor 112 to a new position on the scrubber bar 111. As another example, the user can select the scrubber bar 111 and the cursor 112 will automatically move to the selected position on the scrubber bar 111. For further discussion of this functionality, see the below paragraphs describing FIG. 2.

The user interface 110 may also include a rewind button 113, a skip-back button 114 (e.g., a skip-back-ten-seconds button), a pause button 115, a skip-forward button 116 (e.g., a skip-forward-thirty-seconds button), and a fast-forward button 117. The user can select (e.g., tap, click, press) the skip-back button 114 or the skip-forward button 116 in order to navigate from a current position in the media to another position in the media. For example, as illustrated in FIG. 1A, the skip-back button 114 is a skip-back-ten-seconds button. This is indicated by the number “10” in the middle of the skip-back button 114. Accordingly, the user can select the skip-back button 114 of FIG. 1A in order to navigate to a position in the media that is ten seconds earlier than the currently streaming or playing position.

The rewind button 113 and the fast-forward button 117 may allow the user to navigate to other media (e.g., media stream 139, another song, another episode, another album) that is before or after the current media, respectively. The rewind button 113 and the fast-forward button 117 may allow the user to navigate to other positions in the media currently streaming or playing. For example, if the user holds (e.g., long-presses) the rewind button 113 or the fast-forward button 117, the cursor 112 moves to the left or the right, respectively, and streaming or playing media will adjust accordingly (e.g., by streaming or playing from a position earlier or later, respectively, in the media). The pause button 115 may allow the user to pause the currently streaming or playing media. After a user selects (e.g., taps, clicks, presses) the pause button 115, the user interface 110 may replace the pause button 115 with a play button that allows the user to continue streaming or playing the media.

The media currently streaming or playing at the user device 101 may be sent to the user device 101 by a server 130 in media segments. If the media currently streaming or playing at the user device 101 is large (e.g., five hundred megabytes), it may take a long time (e.g., one minute, ten minutes) to send the entirety of the media to the user device 101. Rather than require the user to wait for the user device 101 to receive all of the media, the user device can begin streaming or playing the media as soon as a media segment (e.g., media segment 140) is received. While the user device 101 streams or plays the media segment, the user device 101 can receive other media segments (e.g., media segments 141-149) from the server 130, thus minimizing user wait time. After streaming or playing through the end of the media segment (e.g., media segment 140), the user device 101 may then begin playing or streaming the next media segment (e.g., media segment 141).

As used herein, “media stream” refers to data that includes media for streaming. For example, a media stream may include a live media stream (e.g., a radio broadcast, a news broadcast). As another example, a media stream may include a pre-recorded media stream (e.g., a music track, a television episode). As used herein, “media segment” refers to a portion of a media stream. For example, a media stream may be divided into multiple ten-second portions. As another example, the media stream may be divided into some minute-long portions, some ten-second portions, and other thirty-second portions. A media segment of a media stream may not overlap with another media segment of the same media stream. For example, if a ten-second media segment corresponds to the first ten seconds of a media stream, another ten-second media segment may not correspond to any of seconds zero through ten of the media stream. The media segments may line up with ideal breakpoints in the media stream (e.g., commercial breaks in a television media stream, breaks between songs in an album media stream) such that one media segment ends and another media segment begins at such a breakpoint.

As illustrated in FIG. 1A, the scrubber bar 111 is shown as “divided” into ten sections 120-129. These divisions are not displayed by the user interface; rather, they are shown for illustrative purposes, as representing portions of the scrubber bar 111 that correspond to media segments 140-149. For example, section 123 of the scrubber bar 111 may correspond to media segment 143. In these embodiments, while the cursor 112 is in section 123, as illustrated in FIG. 1A, the user device 101 is streaming or playing media from media segment 143. As another example, section 120 of the scrubber bar 111 may correspond to media segment 140 of the server 130. If the user were to drag the cursor 112 into section 120 of the scrubber bar 111, the user device 101 would then begin streaming or playing media from media segment 140.

The user device 101 may be in communication with a server 130. The server 130 may host a media stream 131. The server 130 may stream the media stream (e.g., an audio stream, a video stream, a live stream) to the user device 101. This is depicted by the arrow 151 pointing from the server 130 to the user device 101. The media stream 131 may include the aforementioned media segments 140-149. The media stream can also include metadata 132 associated with the one or more media segments 140-149. The metadata 132 may include information relating to the length (e.g., in seconds, minutes) of each media segment 140-149, the size (e.g., in bytes) of each media segment 140-149, the number of media segments 140-149, the content of the media segments 140-149, and so on.

FIG. 1B illustrates a zoomed-in portion of the user interface 110 of FIG. 1A, including the scrubber bar 111, the cursor 112, the rewind button 113, the skip-back button 114, the pause button 115, the skip-forward button 116, and the fast-forward button 117. Additionally, FIG. 1B illustrates the representative “divider lines” that indicate sections 120-129 that represent and correspond to media segments 140-149.

Turning now to FIG. 1C, the user may input a navigation request by dragging the cursor 112 to a new location on the scrubber bar 111. The new location may be in section 128 of the scrubber bar 111.

After the user inputs the navigation request, the user device 101 may send the navigation request to the server 130. This is depicted by the arrow 152 pointing from the user device 101 to the server 130. The navigation request may include a request to navigate to a requested position in the media, wherein the requested position is based on the new location in the scrubber bar 111.

After the server 130 receives the navigation request from the user device 101, the server may locate a media segment (e.g., media segment 148) that corresponds to the requested position in the media stream. Locating the media segment may include using the requested position to search through the metadata 132 of the media stream 131 for the corresponding media segment.

As disclosed herein, in some circumstances, the requested position may not be an optimal or optimal position for re-initiating the media stream for the user. In these instances, the system 100 may be configured to determine adjusted position that is a more optimal or ideal position for re-initiating the media stream.

As used herein, “optimal position” refers to a position within a media stream that meets one or more waveform criteria (e.g., an amplitude criterion, a frequency criterion). The optimal position can be the same as the position requested by the user, or the optimal position can be another position in the media stream (e.g., in the same media segment as the requested position). The optimal position may be a better position to begin playback of a media stream than the requested position. For example, for media including speech (e.g., a podcast, lyrical music), the optimal position may be at the beginning of a sentence. As another example, for media including music (e.g., a song, a film), the optimal position may be at the beginning of a measure. As yet another example, for media including intermittent loud noises (e.g., an action film, percussive music), the optimal position may be just prior to (e.g., one second before, one beat before, five seconds before, four beats before) or just after (e.g., one second after, one beat after) a loud noise (e.g., an explosion, a cymbal crash) as opposed to, for example, in the middle of the loud noise. In some embodiments, the “optimal position” may also be referred to as an “ideal position” or a “quiescent position.”

FIG. 1D illustrates the server 130 and a graphical representation of an audio waveform 248 (also referred to herein as audio waveform 248) of the media segment 148, in accordance with some implementations. As illustrated in FIG. 1D, the media segment 148 may include the audio waveform 248. In this example, the audio waveform 248 includes an x-axis that represents time and a y-axis that represents amplitude. The majority of the following discussion concerns determining an optimal position within the media segment 148 based on the amplitude of the audio waveform 248. However, the optimal position may be determined based on other criteria as well, such as the frequency of the audio waveform 248, or other attributes of the media segment (e.g., speech characteristics).

As illustrated in FIG. 1D, the requested position 201 included in the navigation request that is sent by the user device 101 to the server 130 (e.g., as represented by arrow 152 of FIG. 1C) may correspond to a particular time in the media segment 148 and/or a particular time in the respective waveform 248. As discussed above, starting playback at a position other than the requested position 201 (e.g., an optimal position) may result in an improved user experience. For example, as depicted in FIG. 1D, the amplitude of the waveform at the requested position 201 is relatively high compared to the amplitude of other positions in the audio waveform 248. The high amplitude may correspond to a loud noise (e.g., a cymbal crash, an explosion, a loud note, a yell). Accordingly, initiating an adjusted media stream from the requested position 201 might be startling or jarring for a user of the user device 101.

Thus, the server 130 may apply waveform criteria to determine an optimal position for starting an adjusted media stream. For example, FIG. 1E depicts an amplitude criterion that includes an amplitude threshold 210. The amplitude threshold 210 may be a constant threshold (e.g., 10 dB), or the amplitude threshold 210 may scale based on the audio waveform 248 (e.g., the amplitude of the audio waveform 248).

As depicted in FIG. 1E, the requested position 201 does not satisfy the amplitude criterion because the amplitude of the waveform 248 at the time associated with the requested position 201 is greater than the amplitude threshold 210. However, FIG. 1E depicts multiple other times of the waveform 248 (with corresponding positions in the media segment 148) that do satisfy the amplitude criterion. For example, the amplitude of the left-most time (e.g., associated with 0 seconds through the media segment 148) in the waveform 248 is less than the amplitude threshold 210 and therefore satisfies the amplitude criterion.

To further illustrate this, FIG. 1F denotes positions 220-226 of the waveform 248, in accordance with some implementations. The amplitudes of the waveform 248 at positions 220-226 satisfy the amplitude criterion because the amplitude at each of the positions 220-226 is less than the amplitude threshold 210. Persons skilled in the art will also appreciate that each of the positions 220-226 is associated with a low point (a “valley”) in the waveform 248. The server 130 may include a valley amplitude criterion that is satisfied by low points in the waveform 248, such as at positions 220-226. The server 130 may be able to locate valleys in a waveform.

Accordingly, where the waveform criteria include an amplitude criterion that has an amplitude threshold 210, as depicted in FIGS. 1E and 1F, each of positions 220-226 may be an optimal position. For reasons discussed above, streaming an adjusted media stream (e.g., as suggest by arrow 153 of FIG. 1F) to user device 101 at one of positions 220-226 may provide an improved user experience as compared with initiating an adjusted media stream at the requested position 201.

Alternatively, or in addition to the amplitude criterion example described above, the waveform criteria may include a frequency criterion that is satisfied by any navigation position that has an audio waveform frequency less than or equal to a frequency threshold (e.g., 5 kHz, 10 kHz, 15 kHz). The waveform criteria can include multiple criteria (e.g., an amplitude criterion, a frequency criterion), or it can include a single criterion.

The waveform criteria may not narrow the number of potential positions down to one optimal position. Accordingly, the position that best satisfies the waveform criteria may be selected as the optimal position. For example, the waveform criteria may include a single amplitude criterion (e.g., amplitude threshold 210 of FIGS. 1E and 1F), and multiple positions may satisfy the amplitude criterion (e.g., positions 220-226 of FIG. 1F). Accordingly, selecting the position that best satisfies the amplitude criterion may include selecting the position with the lowest amplitude (e.g., position 225 of FIG. 1F).

As another example of a waveform criterion, the waveform criteria can include a proximity criterion that is satisfied by any navigation position that has a distance from the requested position 201 that is less than a proximity threshold (e.g., one second, two seconds). By way of example, if an optimal position is within one second of the requested position, and the proximity threshold is two seconds or less, then the optimal position could be used for re-initiation of the media stream.

As yet another example, the waveform criteria can include an antecedent criterion that is satisfied by any navigation position that is temporally antecedent to the requested position 201 in the media stream.

As yet another example, the waveform criteria can include a subsequent criterion that is satisfied by any navigation position that is temporally subsequent to the requested position 201 in the media stream.

Each waveform criterion may include both a threshold and/or a weight. The weight may be associated with the importance of the criterion. For example, the most important criterion may be the antecedent criterion. Accordingly, the weight of the antecedent criterion may be greater than the respective weight of each other criterion of the waveform criteria. As another example, the most important criterion may be the amplitude criterion. Accordingly, the weight of the amplitude criterion may be greater than the respective weight of each other criterion of the waveform criteria.

Determining the optimal position within the media segment based on the one or more waveform criteria may include determining one or more potential positions within the media segment that satisfy a primary waveform criterion of the one or more waveform criteria, wherein the weight of the primary waveform criterion is greater than or equal to the weight of each other criteria of the one or more waveform criteria, and selecting the optimal position from among the one or more potential positions based on at least a secondary waveform criterion of the one or more waveform criteria.

For example, the primary and secondary criteria can be, respectively, the antecedent and amplitude criteria. Accordingly, determining the optimal position would first require determining one or more potential positions that satisfy the antecedent criterion. In FIG. 1F, potential positions 220-223 are each temporally antecedent to requested position 201 and therefore satisfy the antecedent criterion. Then, determining the optimal position would require selecting the optimal position from among the potential positions 220-223 based on the amplitude criteria.

Each of potential positions 220-223 is less than the amplitude threshold 210. Accordingly, determining the optimal position may also include varying the threshold of the secondary criterion until only one potential position 220-223 satisfies the threshold of the secondary criterion. For example, tightening (i.e., decreasing) the amplitude threshold 210 until only one potential position 220-223 satisfies the amplitude threshold 210 would eventually result in potential position 221 satisfying the amplitude threshold because the amplitude of potential position 221 is less than that of the other remaining potential positions 220, 222, and 223. Accordingly, the optimal position may be the potential position 221.

FIG. 1G illustrates the server 130 sending an adjusted media stream to the user device 101, in accordance with some implementations. As illustrated in FIG. 1D, after the server 130 receives the navigation request from the device 101, the server 130 may initiate an adjusted media stream to the user device 101 from an adjusted position in the media segment. This is depicted by the arrow 153 pointing from the server 130 to the device 101.

FIG. 2 illustrates a method 300 for navigating media according to a waveform criterion, in accordance with some implementations. In some embodiments, the method 300 may be performed by server 130 of FIGS. 1A-1D. However, it is contemplated that one or more steps of method 300, or any alternative embodiments described herein, may be performed by other components.

In some embodiments, the method 300 includes streaming (301) a media stream to a user device (e.g., user device 101 of FIGS. 1A-1D). In some embodiments, the media stream includes a plurality of media segments. In some embodiments, each media segment of the plurality of media segments corresponds to a separate, distinct, and non-overlapping unit portion of the media stream.

In some embodiments, the method 300 includes receiving (302), from the user device, a request (e.g., as indicated by arrow 152 of FIG. 1C) to navigate from a current position in the media stream to a requested position in the media stream.

In some embodiments, the method 300 includes locating (303) a media segment (e.g., media segment 148 of FIG. 1C) of the plurality of media segments (e.g., media segments 140-149 of FIG. 1C), wherein the media segment corresponds to the requested position (e.g., requested position 201 of FIGS. 1D-1F) in the media stream.

In some embodiments, the method 300 includes determining (304) an optimal position within the media segment based on the one or more waveform criteria (e.g., an amplitude criterion that includes an amplitude threshold, such as amplitude threshold 210 of FIGS. 1E and 1F).

In some embodiments, determining the optimal position within the media segment based on the one or more waveform criteria includes determining one or more potential positions within the media segment that satisfy a primary waveform criterion of the one or more waveform criteria. For example, as illustrated in FIG. 1F, positions 220-226 of the waveform 248 denote potential positions that satisfy primary waveform criteria that include an amplitude criterion, in accordance with some implementations. The amplitudes of the waveform 248 at positions 220-226 satisfy the amplitude criterion because the amplitude at each of the positions 220-226 is less than the amplitude threshold 210.

In some embodiments, the primary waveform criterion is an antecedent criterion that is satisfied by any navigation position that is temporally antecedent to the requested position. For example, as illustrated in FIG. 1F, each of positions 220-223 satisfies the antecedent criterion because they are each temporally antecedent to the requested position 201.

In some embodiments, the primary waveform criterion is an amplitude criterion that is satisfied by any navigation position that has an audio waveform amplitude less than an amplitude threshold. For example, as illustrated in FIG. 1F, each of positions 220-226 has an amplitude that is less than the amplitude threshold 210. Accordingly, each of positions 220-226 would satisfy an amplitude criterion that includes the amplitude threshold 210 as its amplitude threshold.

In some embodiments, determining the optimal position within the media segment based on the one or more waveform criteria includes selecting the optimal position from among the one or more potential positions based on at least a secondary waveform criterion of the one or more waveform criteria. For example, in FIG. 1F, position 225 is selected as the optimal position because it has the lowest amplitude.

In some embodiments, the optimal position in the media stream is different from the requested position in the media stream. For example, referring to FIG. 1F, each of positions 220-226 might be selected as an optimal position. And each of positions 220-226 is different than the requested position 201.

In some embodiments, the media stream comprises audio media. For example, the media stream might include a film score, such as in a feature film. As another example, the media stream might include music, such as in an album. As yet another example, the media stream might include audible dialogue, such as in a podcast.

In some embodiments, the media stream comprises video media. For example, the media stream might include a slideshow, such as in a presentation. As another example, the media stream might include album art, such as for an album. As yet another example, the media stream might include a film, such as for a movie.

In some embodiments, the method 300 further includes varying the secondary waveform criterion until only one potential position of the one or more potential positions satisfies the secondary waveform criterion. For example, referring to FIG. 1F, if the primary waveform criterion was an antecedent criterion, each of positions 220-223 would satisfy the primary waveform criterion. Accordingly, if the secondary waveform criterion was an amplitude criterion, selecting an optimal position might include varying (e.g., decreasing) the amplitude threshold until only one of the positions that satisfied the primary waveform criterion also satisfies the variable secondary threshold. For example, decreasing the amplitude threshold until only position 221 satisfies the amplitude threshold because the amplitude of position 221 is less than all other positions that also satisfy the primary threshold. In some embodiments, criterion described as primary criterion or secondary criterion may be applied in orders that are different than the orders as described herein.

In some embodiments, at least one criterion of the one or more waveform criteria includes a threshold and a weight. In some embodiments, the weight of the at least one criterion is associated with the importance of the criteria. For example, referring to FIGS. 1A-1D, if someone determines that it is especially important to users that the optimal position is either the same as or antecedent to the selected position, then the server 130 might set the weight of an antecedent criterion of the waveform criteria as the highest priority (e.g., ten out of ten where ten represents the maximum weight given to a waveform criterion).

In some embodiments, determining the optimal position within the media segment based on the one or more waveform criteria includes determining one or more potential positions within the media segment that satisfy a primary waveform criterion of the one or more waveform criteria. In some embodiments, the weight of the primary waveform criterion is greater than or equal to the weight of each other criteria of the one or more waveform criteria. For example, as discussed above, in some embodiments, the weight of the waveform criteria corresponds to the importance of the criteria. For example, the weight of the waveform criteria may correspond to the importance of the criteria to a user.

In some embodiments, determining the optimal position within the media segment based on the one or more waveform criteria further includes selecting the optimal position from among the one or more potential positions based on at least a secondary waveform criterion of the one or more waveform criteria. For example, in embodiments where the weight of the criterion is associated with the importance of the criterion, selecting the optimal position by filtering out positions that do not satisfy the primary waveform criterion (e.g., the most important waveform criterion), the secondary waveform criterion (e.g., the second-most important waveform criterion), and so on ensures that the optimal position satisfies as many high-weight (e.g., high-importance) waveform criteria as possible.

In some embodiments, the method 300 further includes varying the threshold of the secondary waveform criterion until only one potential position of the one or more potential positions satisfies the waveform criterion. For example, as discussed above, selecting the optimal position may include varying (e.g., increasing, decreasing, tightening) a threshold of a waveform criterion in order to narrow down the number of positions to just one. For example, the method 300 may include varying the secondary waveform criterion if multiple positions satisfy the secondary waveform criterion.

In some embodiments, the one or more waveform criteria include a proximity criterion that is satisfied by any navigation position that has a distance from the requested position that is less than a proximity threshold. For example, in some embodiments, the proximity threshold is five hundred milliseconds. Referring to FIG. 1F, positions 223-225 might satisfy a proximity threshold because they are close to the requested position 201, although of course whether the positions satisfy the proximity threshold depends on the tolerance (e.g., the width) of the threshold.

In some embodiments, the one or more waveform criteria include a subsequent criterion that is satisfied by any navigation position that is temporally subsequent to the requested position in the media stream. For example, referring to FIG. 1F, positions 224-226 each satisfy the subsequent criterion because they are each temporally subsequent to the requested position 201.

In some embodiments, the method 300 includes streaming (305) the media stream (e.g., media stream 131 of FIGS. 1A-1F) to the user device (e.g., user device 101 of FIGS. 1A-1D) from the optimal position (e.g., position 225 of FIG. 1F) in the media segment.

In some embodiments, a machine learning model or neural network may be used to determine waveform criteria for determining an optimal position. The model or network may be trained using historical waveform data from the media segments with optimal positions identified. In some embodiments, a machine learning model or neural network may be used to determine weights or thresholds for predetermined waveform criteria. For example, a machine learning model or neural network may be used to determine whether an amplitude criterion ought to have a lower weight (e.g., be of lower priority than) a frequency criterion. In some embodiments, a machine learning model or neural network may be used to identify waveform criteria.

In some embodiments, the method 300 further includes displaying, at the user device, an indication of the current position in the media stream and/or an option to navigate from the current position in the media stream to the other portion of the media stream. For example, the display might indicate the current position in the media stream using a cursor and a scrubber bar, such as cursor 112 and scrubber bar 111 of FIGS. 1A-1D. Further, the navigation options of the display might include the buttons 113-117 of FIGS. 1A-1D, in addition to the aforementioned scrubber bar 111 and cursor 112.

It will be appreciated by those skilled in the art that changes could be made to the exemplary embodiments shown and described above without departing from the broad inventive concepts thereof. It is understood, therefore, that this invention is not limited to the exemplary embodiments shown and described, but is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a,” “an” and “the” are not limited to one element but instead should be read as meaning “at least one.”

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A method of navigating a media stream, comprising:
streaming a media stream to a user device, wherein the media stream comprises a plurality of media segments, and each media segment of the plurality of media segments corresponds to a non-overlapping portion of the media stream;
while streaming the media stream to the user device:
receiving, from the user device, a request to navigate from a current position in the media stream to a requested position in the media stream;
locating a media segment of the plurality of media segments, wherein the media segment corresponds to the requested position in the media stream;
determining an optimal position within the media segment based on one or more waveform criteria; and
streaming the media stream to the user device from the optimal position in the media segment.

2. The method of claim 1, wherein determining the optimal position within the media segment based on the one or more waveform criteria comprises:
determining one or more potential positions within the media segment that satisfy a primary waveform criterion of the one or more waveform criteria; and
selecting the optimal position from among the one or more potential positions based on at least a secondary waveform criterion of the one or more waveform criteria.

3. The method of claim 2, wherein the primary waveform criterion is an antecedent criterion that is satisfied by any navigation position that is temporally antecedent to the requested position in the media stream.

4. The method of claim 2, wherein the primary waveform criterion is an amplitude criterion that is satisfied by any navigation position that has an audio waveform amplitude less than an amplitude threshold.

5. The method of claim 2, further comprising varying the secondary waveform criterion until only one potential position of the one or more potential positions satisfies the secondary waveform criterion.

6. The method of claim 1, wherein each criterion of the one or more waveform criteria comprises a threshold and a weight, wherein the weight is associated with an importance of the criteria.

7. The method of claim 5, wherein determining the optimal position within the media segment based on the one or more waveform criteria comprises:
determining one or more potential positions within the media segment that satisfy a primary waveform criterion of the one or more waveform criteria, wherein the weight of the primary waveform criterion is greater than or equal to the weight of each other criteria of the one or more waveform criteria; and
selecting the optimal position from among the one or more potential positions based on at least a secondary waveform criterion of the one or more waveform criteria.

8. The method of claim 7, further comprising varying the threshold of the secondary waveform criterion until only one potential position of the one or more potential positions satisfies the secondary waveform criterion.

9. The method of claim 1, wherein the one or more waveform criteria comprise an amplitude criterion that is satisfied by any navigation position that has an audio waveform amplitude less than an amplitude threshold.

10. The method of claim 1, wherein the one or more waveform criteria comprise a frequency criterion that is satisfied by any navigation position that has an audio waveform frequency less than or equal to a frequency threshold.

11. The method of claim 1, wherein the one or more waveform criteria comprise a proximity criterion that is satisfied by any navigation position that has a distance from the requested position that is less than a proximity threshold.

12. The method of claim 1, wherein the one or more waveform criteria comprise an antecedent criterion that is satisfied by any navigation position that is temporally antecedent to the requested position in the media stream.

13. The method of claim 1, wherein the one or more waveform criteria comprise a subsequent criterion that is satisfied by any navigation position that is temporally subsequent to the requested position in the media stream.

14. The method of claim 1, further comprising displaying, at the user device, an indication of the current position in the media stream and an option to navigate from the current position in the media stream to the other portion of the media stream.

15. The method of claim 1, wherein the optimal position in the media stream is different from the requested position in the media stream.

16. The method of claim 1, wherein the media stream comprises audio media.

17. The method of claim 1, wherein the media stream comprises video media.

18. The method of claim 1, wherein the media stream comprises a live stream.

19. An electronic device, comprising:
one or more processors; and
memory storing one or more programs, the one or more programs including instructions, which, when executed by the one or more processors, cause the electronic device to perform the method of claim 1.

20. A non-transitory, computer-readable medium, storing one or more programs, the one or more programs including instructions, which, when executed by one or more processors of an electronic device, cause the electronic device to perform the method of claim 1.
